(19) United States
(12) Patent Application Publication
(10) Pub. No.: US 2018/0022958 A1
(43) Pub. Date: Jan. 25, 2018

(54) HARD COATING COMPOSITION, AND HARD COATING FILM AND COATED ARTICLE USING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/487,622

(22) Filed: Apr. 14, 2017

(30) Foreign Application Priority Data
Jul. 22, 2016 (TW) 105123337

(51) Int. Cl. C09D 187/00

(52) U.S. Cl. CPC C09D 187/00; C08K 3/22

(57) ABSTRACT

A hard coating composition comprises a dopamine, a plurality of inorganic oxide particles, and a solvent. The dopamine reduces the film forming time of an anti-fogging coating. A hard coating film using the hard coating composition, and a coated article using the hard coating film are also provided.

### FIELD

The subject matter herein generally relates to a coating composition, and more particularly, to a hard coating composition, a hard coating film using the hard coating composition, and a coated article using the hard coating film.

### BACKGROUND

A hard coating film can be attached to a surface of an article, to prevent the article from being damaged. As the hard coating film is set on the surface of the article, the hard coating film needs to keep shape, hardness, or size unchanged, to ensure the article has a good appearance. The hard coating film is generally formed by a hard coating composition.

### BRIEF DESCRIPTION OF THE DRAWINGS

Implementations of the present technology will now be described, by way of example only, with reference to the attached figures.

FIG. 1 is a diagrammatic view of an exemplary embodiment of a coated article of the present disclosure.

FIG. 2 is a cross-sectional view along line II-II of FIG. 1.

FIG. 3 illustrates a flowchart of a method for making a coated article in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

Several definitions that apply throughout this disclosure will now be presented.

The term “comprising” when utilized, means “including, but not necessarily limited to”; it specifically indicates open-ended inclusion or membership in the so-described combination, group, series, and the like. The term “about” when utilized, means “not only includes the numerical value, but also include numbers closest to the numerical value”.

An exemplary embodiment of a hard coating composition comprises a dopamine, a plurality of inorganic oxide particles, and a solvent.

The dopamine has a mass percentage of about 1% to about 40% of a total mass of the hard coating composition. The plurality of the inorganic oxide particles has a mass percentage of about 40% to about 80% of the total mass of the hard coating composition. The solvent has a mass percentage of about 5% to about 50% of the total mass of the hard coating composition.

In at least one exemplary embodiment, the hard coating composition has a PH value of about 8.0 to about 10.5. The PH value is conducive to oxidation of the dopamine.

A chemical structure formula of the dopamine is:

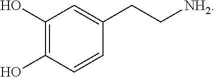 [SMILES: NCCc1ccc(O)c(O)c1]

The dopamine has a catechol functional group. When the hard coating composition is put in an alkaline or an oxidizing condition, the catechol functional group of the dopamine can be oxidized to form a dopamine quinone containing a benzoquinone structure. The dopamine quinone can disproportionately react with the dopamine to form a semi-quinone radical, and couple to form a cross-linking bond, thereby a polymer with a cross-linking structure is formed. Thereby, a hard coating film can be formed. The inorganic oxide particles are dispersed in the cross-linking structure.

The plurality of inorganic oxide particles may be selected from particles of silica, zirconia, alumina, titanium, or any combination thereof. The inorganic oxide particle can increase a hardness and a refractive index of a hard coating film formed by the hard coating composition.

A particle diameter of the inorganic oxide particle may be about 1 nm to about 1000 nm. Preferably, the particle diameter of the inorganic oxide particle is about 1 nm to about 300 nm.

The solvent may be water, an alcohol aqueous solution, or an oxidizing aqueous solution. The alcohol aqueous solution may be a methanol aqueous solution, an ethanol aqueous solution, or a propanol aqueous solution. The oxidizing aqueous solution may be sodium periodate (NaIO₄) aqueous solution. When the solvent is alcohol aqueous solution or oxidizing aqueous solution, the PH of the hard coating composition may be adjusted to in a range of about 8.0 to about 10.5 by a sodium hydroxide solution.

The hard coating composition does not include an organic solvent, so the hard coating composition is environmentally friendly.

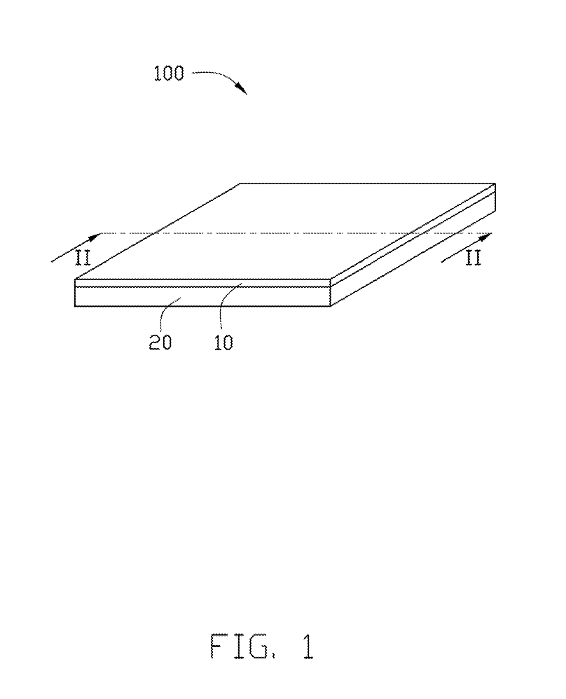

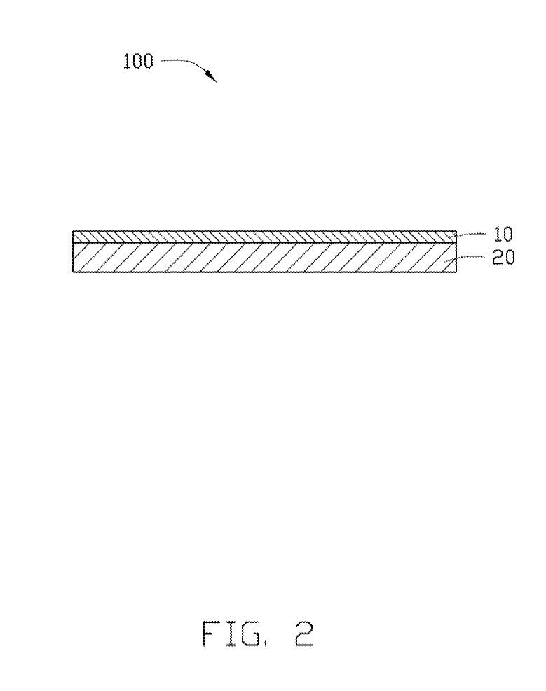

FIG. 1 and FIG. 2 illustrate a coated article 100. The coated article 100 includes a substrate 20 and a hard coating film 10 attached to at least one surface of the substrate 20. The hard coating film 10 is formed by coating the hard coating composition on the surface of the substrate 20, and drying the hard coating composition.

The hard coating film 10 comprises a polymer of dopamine. The polymer has a cross-linking structure. The hard coating film 10 further comprises a plurality of inorganic oxide particles dispersed in the cross-linking structure. The hard coating film 10 is resistant to yellowing in the sunlight.

A material of the substrate 20 may be glass, resin, metal, oxide, semiconductor, ceramic, polymer, or wood.

The coated article 100 may be a lens, a window glass, or a lamp shell.

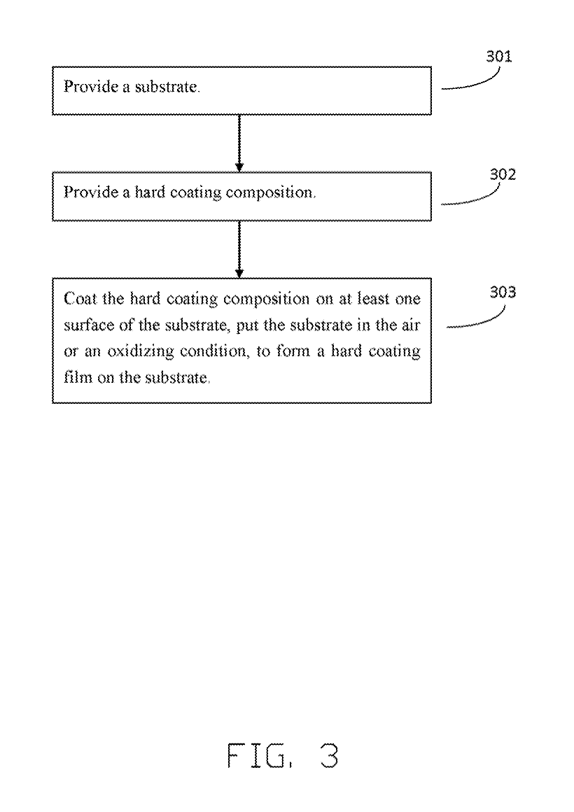

FIG. 3 illustrates a flowchart of a method for making the coated article 100 in accordance with an exemplary embodiment. The exemplary method is provided by way of example, as there are a variety of ways to carry out the method. Each block shown in FIG. 3 represents one or more processes, methods or subroutines, carried out in the exemplary method. Furthermore, the illustrated order of blocks is by example only, and the order of the blocks can change. Additional blocks may be added, or fewer blocks may be utilized, without departing from this disclosure. The exemplary method may begin at block 301.

At block 301, a substrate 20 is provided. The substrate 20 may be made of glass, resin, metal, oxide, semiconductor, ceramic, polymer, or wood.

At block 302, a hard coating composition is provided. The hard coating composition comprises a dopamine, a plurality of inorganic oxide particles, and a solvent. The dopamine has a mass percentage of about 1% to about 40% of a total mass of the hard coating composition. The plurality of the inorganic oxide particles has a mass percentage of about 40% to about 80% of the total mass of the hard coating composition. The solvent has a mass percentage of about 5% to about 50% of the total mass of the hard coating composition.

At block 303, at least one surface of the substrate 20 is coated with the hard coating composition, and then put in the air or an oxidizing condition to have the dopamine in the hard coating composition react, to form a hard coating film 10 on the substrate 20.

The hard coating film 10 and the substrate 20 are bonded together by a covalent bond, an intermolecular interaction force, a hydrogen bond, a π-π bond, or any combination thereof. Thereby an adhesion strength between the hard coating film 10 and the substrate 20 is strong.

An oxidation rate of the dopamine in the alkaline or oxidizing condition is rapid, thereby the hard coating film 10 can be formed on the surface of the substrate 20 quickly.

In at least one exemplary embodiment, the hard coating composition is coated on the at least one surface of the substrate 20 by spray coating process or spin coating process. In another exemplary embodiment, the hard coating composition is coated on the surface of the substrate 20 by immersing the substrate 20 into the hard coating composition, and then taking the substrate 20 out, thereby a portion of the hard coating composition is adsorbed on the surface of the substrate 20.

### Example 1

The hard coating composition comprised dopamine, silica particles, zirconia particles, and methanol aqueous solution.

The dopamine had a mass percentage of 13.05% of the total mass of the hard coating composition. The silica particles had a mass percentage of 29.88% of the total mass of the hard coating composition. The zirconia particles had a mass percentage of 36.53% of the total mass of the hard coating composition. The methanol aqueous solution had a mass percentage of 10% of the total mass of the hard coating composition.

The substrate 20 was immersed into the hard coating composition for 2 hours, and then taken out, a hard coating film 10 was formed on the surface of the substrate 20.

The hard coating film 10 was subjected to a surface hardness test and an adhesion strength test under ASTM standard. The surface hardness test was carried out by a pencil hardness test method, the surface hardness test result showed that the surface hardness of the hard coating film 10 was 2H. The adhesion strength test result showed the ASTM standard was 5B. In other words, the hard coating film 10 was not liable to peeling.

### Example 2

The hard coating composition comprised dopamine, silica particles, zirconia particles, titanium particles, and sodium periodate aqueous solution.

The dopamine had a mass percentage of 21.06% of the total mass of the hard coating composition. The silica particles had a mass percentage of 23.136% of the total mass of the hard coating composition. The zirconia particles had a mass percentage of 26.028% of the total mass of the hard coating composition. The titanium particles had a mass percentage of 8.676% of the total mass of the hard coating composition. The sodium periodate aqueous solution had a mass percentage of 21.1% of the total mass of the hard coating composition.

The substrate 20 was immersed into the hard coating composition for 0.5 hour, and then taken out, a hard coating film 10 was formed on the surface of the substrate 20.

The hard coating film 10 was subjected to a surface hardness test and an adhesion strength test under ASTM standard. The surface hardness test was carried out by a pencil hardness test method, the surface hardness test result showed that the surface hardness of the hard coating film 10 was 2H. The adhesion strength test result showed the ASTM standard was 5B. In other words, the hard coating film 10 was not liable to peeling.

Referring to the examples 1-2, the hard coating film 10 has a high surface hardness and a strong adhesion strength. A high surface hardness means a high scratch resistance.

The embodiments shown and described above are only examples. Even though numerous characteristics and advantages of the present technology have been set forth in the foregoing description, together with details of the structures and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. A hard coating composition comprising:
a dopamine;
a plurality of inorganic oxide particles; and
a solvent.

2. The hard coating composition of claim 1, wherein the dopamine has a mass percentage of about 1% to about 40% of a total mass of the hard coating composition, the plurality of the inorganic oxide particles has a mass percentage of about 40% to about 80% of the total mass of the hard coating composition, the solvent has a mass percentage of about 5% to about 50% of the total mass of the hard coating composition.

3. The hard coating composition of claim 1, wherein the hard coating composition has a PH value of about 8.0 to about 10.5.

4. The hard coating composition of claim 1, wherein the plurality of inorganic oxide particles is selected from particles of silica, zirconia, alumina, titanium, or any combination thereof.

5. The hard coating composition of claim 1, wherein a particle diameter of the inorganic oxide particle is about 1 nm to about 1000 nm.

6. The hard coating composition of claim 1, wherein the solvent is water, an alcohol aqueous solution, or an oxidizing aqueous solution.

7. The hard coating composition of claim 6, wherein the alcohol aqueous solution is a methanol aqueous solution, an ethanol aqueous solution, or a propanol aqueous solution, and the oxidizing aqueous solution is sodium periodate aqueous solution.

8. A hard coating film formed from:
a hard coating composition, the hard coating composition comprising:
a dopamine;
a plurality of inorganic oxide particles; and
a solvent.

9. The hard coating film of claim 8, wherein the dopamine has a mass percentage of about 1% to about 40% of a total mass of the hard coating composition, the plurality of the inorganic oxide particles has a mass percentage of about 40% to about 80% of the total mass of the hard coating composition, the solvent has a mass percentage of about 5% to about 50% of the total mass of the hard coating composition.

10. The hard coating film of claim 8, wherein the hard coating composition has a PH value of about 8.0 to about 10.5.

11. The hard coating film of claim 8, wherein the plurality of inorganic oxide particles is selected from particles of silica, zirconia, alumina, titanium, or any combination thereof.

12. The hard coating film of claim 8, wherein a particle diameter of the inorganic oxide particle is about 1 nm to about 1000 nm.

13. The hard coating film of claim 8, wherein the solvent is water, an alcohol aqueous solution, or an oxidizing aqueous solution.

14. The hard coating film of claim 13, wherein the alcohol aqueous solution is a methanol aqueous solution, an ethanol aqueous solution, or a propanol aqueous solution, and the oxidizing aqueous solution is sodium periodate aqueous solution.

15. A coated article comprising:
a substrate; and
a hard coating film attached to at least one surface of the substrate, the hard coating film is formed from a hard coating composition, the hard coating composition comprising:
a dopamine;
a plurality of inorganic oxide particles; and
a solvent.

16. The coated article of claim 15, wherein the dopamine has a mass percentage of about 1% to about 40% of a total mass of the hard coating composition, the plurality of the inorganic oxide particles has a mass percentage of about 40% to about 80% of the total mass of the hard coating composition, the solvent has a mass percentage of about 5% to about 50% of the total mass of the hard coating composition.

17. The coated article of claim 15, wherein the hard coating composition has a PH value of about 8.0 to about 10.5.

18. The coated article of claim 15, wherein the plurality of inorganic oxide particles is selected from particles of silica, zirconia, alumina, titanium, or any combination thereof.

19. The coated article of claim 15, wherein a particle diameter of the inorganic oxide particle is about 1 nm to about 1000 nm.

20. The coated article of claim 15, wherein the solvent is water, an alcohol aqueous solution, or an oxidizing aqueous solution, the alcohol aqueous solution is a methanol aqueous solution, an ethanol aqueous solution, or a propanol aqueous solution, and the oxidizing aqueous solution is sodium periodate aqueous solution.
